(19) United States
(12) Patent Application Publication
(10) Pub. No.: US 2013/0292605 A1
(43) Pub. Date: Nov. 7, 2013

(54) NEGATIVE ELECTRODE MATERIAL POWDER FOR LITHIUM ION SECONDARY BATTERY, NEGATIVE ELECTRODE FOR LITHIUM ION SECONDARY BATTERY USING THE SAME, AND LITHIUM ION SECONDARY BATTERY USING THE SAME

(71) Applicants: Shingo Kizaki, Amagasaki-shi (JP); Hideaki Kanno, Amagasaki-shi (JP)

(72) Inventors: Shingo Kizaki, Amagasaki-shi (JP); Hideaki Kanno, Amagasaki-shi (JP)

(73) Assignee: OSAKA TITANIUM, Amagasaki-shi, Hyogo (JP)

(21) Appl. No.: 13/977,832

(22) PCT Filed: Jan. 4, 2012
(86) PCT No.: PCT/JP2012/000004

§ 371 Date: Jul. 1, 2013

(30) Foreign Application Priority Data
Jan. 7, 2011 (JP) 2011-002224

(51) Int. Cl. H01M 4/58

(52) U.S. Cl. CPC H01M 4/5825
USPC 252/182.1

(57) ABSTRACT

Provided is a negative electrode material powder for a lithium ion secondary battery, including SiOₓ (0.4≦x≦1.2), in which ¹H is inevitably included therein and a peak area of a chemical shift of 0.2-0.4 ppm is between 5% and 40% of an entire peak area in a spectrum ¹H measured by means of nuclear magnetic resonance spectroscopy. A peak area of a chemical shift of 1.1-2.0 ppm is preferably between 5% and 95% of the entire peak area in a spectrum for ¹H measured by means of nuclear magnetic resonance spectroscopy

As a result, there can be provided a negative electrode material powder for a lithium ion secondary battery used in a lithium ion secondary battery having a large discharge capacity, satisfactory initial efficiency, and cycle characteristics.

### TECHNICAL FIELD

The present invention relates to a negative electrode material powder that makes it possible to obtain a lithium ion secondary battery having a large discharge capacity and satisfactory cycle characteristics. Moreover, the present invention relates to a negative electrode for a lithium ion secondary battery using the negative electrode material powder, and a lithium ion secondary battery using the same.

### BACKGROUND ART

Recently, with a remarkable development of portable electronic devices, communication devices, and the like, development of a secondary battery having a high energy density is strongly demanded in view of economic efficiency and reduction of size and weight of these devices. Presently, exemplary secondary batteries having a high energy density include nickel cadmium batteries, nickel metal hydride batteries, lithium ion secondary batteries, polymer batteries, and the like. Among these batteries, the lithium ion secondary battery has a particularly longer service life and a particularly higher capacity than those of other batteries such as the nickel cadmium battery and the nickel metal hydride battery, and demand for it thus significantly increases in the power supply market.

FIG. 1 shows a configuration example of a lithium ion secondary battery in a coin shape. The lithium ion secondary battery comprises a positive electrode 1, a negative electrode 2, a separator 3 being impregnated with an electrolyte, and a gasket 4 that maintains electrical insulation between the positive electrode 1 and the negative electrode 2 and seals the filling inside the battery, as shown in FIG. 1. Upon charging/discharging, lithium ions go back and forth via the electrolyte in the separator 3 between the positive electrode 1 and the negative electrode 2.

The positive electrode 1 comprises a counter electrode case 1a, a counter electrode current collector 1b, and a counter electrode 1c, in which lithium cobalt oxide (LiCoO₂) and Lithium Manganese Oxide (LiMn₂O₄) are mainly used for the counter electrode 1c. The negative electrode 2 comprises a working electrode case 2a, a working electrode current collector 2b, and a working electrode 2c, and a negative electrode material used for the working electrode 2c is generally formed by an active material (negative electrode active material) that is capable of occluding and releasing lithium ions, a conductive additive, and a binder.

Conventionally, a carbon based material has been used as negative electrode active material for lithium ion secondary batteries. Moreover, as a new negative electrode active material which increases the capacity of lithium ion secondary batteries compared to carbon based material, a complex oxide of lithium and boron, a complex oxide of lithium and a transition metal (such as V, Fe, Cr, Mo and Ni), a compound containing Si, Ge or Sn, N, and O, Si particles of which surfaces are coated with a carbon layer through a chemical deposition process, and the like are proposed.

Although any of these negative electrode active materials is capable of increasing charging/discharging capacity to enhance energy density, they give rise to a large amount of expansion and contraction when lithium ions are occluded and released. As a result, lithium ion secondary batteries using these negative electrode active materials present an insufficient sustainability of discharge capacity (referred to as “cycle characteristic” hereinafter) after repeated charging/discharging.

Meanwhile, the use of silicon oxide powders represented by SiO (0<x≦2) such as SiO as a negative electrode active material has been attempted (refer to Patent Literature 1). The proposed silicon oxide contains lithium in its crystal structure or amorphous structure, and constructs a complex oxide of lithium and silicon so as to occlude and release lithium ions as a result of an electrochemical reaction in a nonaqueous electrolyte. Silicon oxide is a collective term for oxide of silicon amorphous obtained by heating a mixture of silicon dioxide and silicon and cooling the generated silicon monoxide gas to be deposited, and is put into practical use as a vapor deposition material.

Silicon oxide gives rise to a small amount of degradation such as collapse of the crystal structure and generation of irreversible substances as a result of occlusion and release of lithium ions during charging and discharging, and can be a negative electrode active material having a higher effective charge/discharge capacity. Therefore, a lithium ion secondary battery having a higher capacity compared to the case where the carbon is used, and having satisfactory cycle characteristics compared to the case where a high capacity negative electrode active material such as Si or an Sn alloy is used is obtained by using silicon oxide as a negative electrode active material.

### CITATION LIST

### Patent Literature

PATENT LITERATURE 1 Japanese Patent No. 2997741

### SUMMARY OF THE INVENTION

### Technical Problem

However, according to the study by present inventors, there is such a problem that the lithium ion secondary battery described in Patent Literature 1 does not sufficiently satisfy a discharge capacity that is currently required, and a ratio (hereinafter, referred to as “initial efficiency”) of a discharge capacity to a charge capacity is intrinsically low during the initial charging/discharging.

The present invention is devised in view of this problem, and has an object to provide a negative electrode material powder for a lithium ion secondary battery having an excellent discharge capacity and initial efficiency and satisfactory cycle characteristics, a negative electrode for a lithium ion secondary battery using the negative electrode material powder, and a lithium ion secondary battery using the same.

### Solution to Problem

The present inventors have studied a treatment method of silicon oxide in order to solve the above-described problem. As a result, the inventors have found that the discharge capacity and the initial efficiency of lithium ion secondary battery can be increased by applying modification/reforming treatment to SiO, (0.4<x≦1.2) powders using SiClₓ (1≦x≦4), while the cycle characteristics thereof are maintained.

The inventors have studied further, and have found that the modification/reforming treatment using SiClₓ increases the discharge capacity and the initial efficiency if a peak area of the chemical shift of 0.2-0.4 ppm is between 5% and 40% of an entire peak area in a spectrum of ¹H, which is inevitably included in the SiOₓ powders, the spectrum being measured by means of nuclear magnetic resonance (NMR) spectroscopy, and further increases them if a peak area of chemical shift of 1.1-2.0 ppm is between 5% and 95% of the entire peak area.

The present invention has been made based on the above-described findings, and summaries thereof consist in a negative electrode powder for a lithium ion secondary battery in the following (1) and (2), and a negative electrode for a lithium ion secondary battery in the following (3), and a lithium ion secondary battery in the following (4).

(1) A negative electrode material powder for a lithium ion secondary battery, including SiOₓ (0.4≦x≦1.2), in which ¹H is inevitably included therein and a peak area of a chemical shift of 0.2-0.4 ppm is between 5% and 40% of an entire peak area in a spectrum of ¹H measured by means of nuclear magnetic resonance spectroscopy.

(2) The negative electrode material powder for a lithium ion secondary battery according to the above (1), wherein a peak area of a chemical shift of 1.1-2.0 ppm is between 5% and 95% of the entire peak area in a spectrum of ¹H measured by means of nuclear magnetic resonance spectroscopy.

(3) A negative electrode for a lithium ion secondary battery using the negative electrode material powder for a lithium ion secondary battery according to the above (1) or (2).

(4) A lithium ion secondary battery using the negative electrode for a lithium ion secondary battery according to the above (3).

### Advantageous Effects of Invention

A lithium ion secondary battery having an excellent discharge capacity and initial efficiency and satisfactory cycle characteristics can be obtained by using a negative electrode material powder for a lithium ion secondary battery and a negative electrode for a lithium ion secondary battery according to the present invention. Moreover, the lithium ion secondary battery according to the present invention has an excellent discharge capacity and initial efficiency and satisfactory cycle characteristics.

### BRIEF DESCRIPTION OF THE DRAWINGS

FIG. 1 is a diagram showing a configuration example of a lithium ion secondary battery in a coin shape.

FIG. 2 depict the NMR spectra of SiO powders, in which FIG. 2(a) shows a case where the limitations of the present invention are not satisfied, and FIG. 2(b) shows a case where the limitations of the present invention are satisfied.

FIG. 3 is a diagram showing a configuration example of a silicon oxide manufacturing device.

### DESCRIPTION OF EMBODIMENTS

### 1. Negative Electrode Material Powder for Lithium Ion Secondary Battery According to Present Invention

A negative electrode material powder for a lithium ion secondary battery according to the present invention includes SiO (0.4≦x≦1.2), in which ¹H is inevitably included therein and a peak area of a chemical shift of 0.2-0.4 ppm is between 5% and 40% of an entire peak area in a spectrum (also simply referred to as “NMR spectrum” hereinafter) of ¹H measured by means of nuclear magnetic resonance (NMR) spectroscopy.

The nuclear magnetic resonance is a resonance phenomenon that is generated if a material including nuclei (such as ¹H and ¹³C) having a magnetic moment is placed in a magnetic field, and an electromagnetic wave at a frequency satisfying a resonance condition is applied. A state of coupling to neighboring atoms is detected as a chemical shift for the nucleus having the magnetic moment according to the spectrum measured by the NMR.

SiO, powders are admixed with H atoms when in the form of a raw material or in a manufacturing process, and H atoms of an approximately 80 mass ppm are inevitably admixed in a general manufacturing method (including a manufacture described later). The present inventors have found that a state of coupling of H atoms to neighboring atoms affects a discharge capacity and initial efficiency of the lithium ion secondary battery using the SiOₓ powders as negative electrode material powder as a result of study.

In other words, if the peak area of a chemical shift of 0.2-0.4 ppm is between 5% and 40% of the entire peak area in the NMR spectrum, the discharge capacity and initial efficiency of the lithium ion secondary battery using the SiOₓ powders as negative electrode material powder can be increased.

Further, if a peak area of a chemical shift of 1.1-2.0 ppm is between 5% and 95% of the entire peak area in the NMR spectrum, the discharge capacity and the initial efficiency can further be increased.

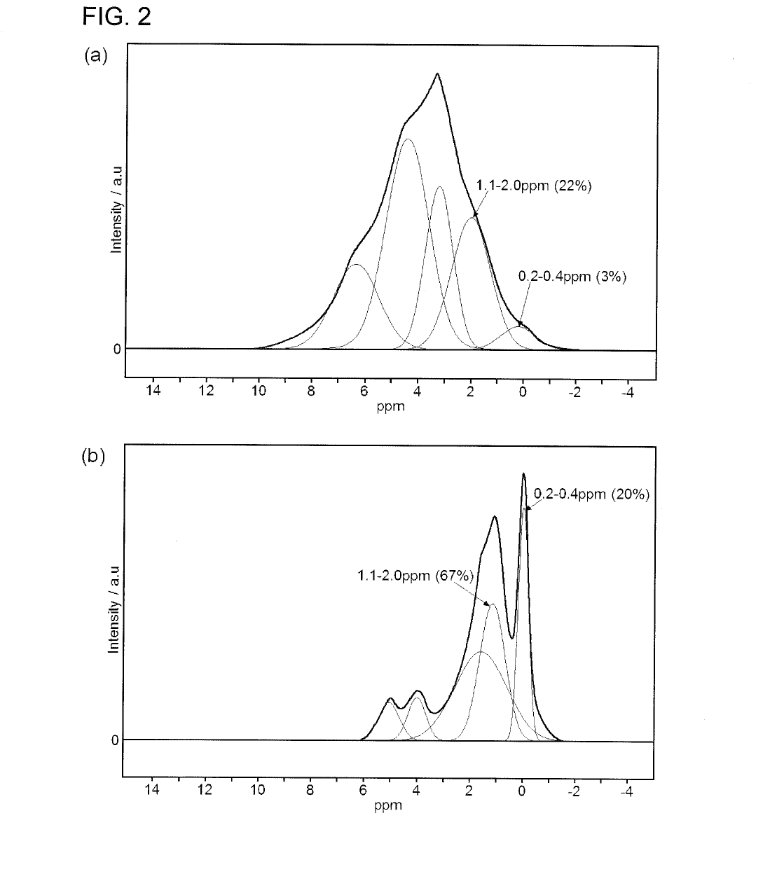

FIG. 2 depict the NMR spectra of SiO powders, FIG. 2(a) shows a case where the limitations of the present invention are not satisfied, and FIG. 2(b) shows a case where the limitations of the present invention are satisfied. The SiOₓ powders shown in FIG. 2(a) have a peak area of a chemical shift of 0.2-0.4 ppm, which is 3% of the entire peak area, and does not satisfy the limitations of the present invention. The peak area of a chemical shift of 1.1-2.0 ppm is 22% of the entire peak area. Moreover, the SiOₓ powders shown in FIG. 2(b) have peak areas of a chemical shift of 0.2-0.4 ppm and a chemical shift of 1.1-2.0 ppm, which are 20% and 67% of the entire peak area, respectively, and satisfy the limitations of the present invention.

The state of coupling between H atoms and the neighboring atoms can be controlled through reforming treatment for SiO powders using after-mentioned SiClₓ (1<x<4). Cl atoms, which are attached to the surfaces of SiO powders through the reforming treatment, adversely affect the discharge capacity, the initial efficiency, and the cycle characteristics of a lithium ion secondary battery. Therefore, a smaller quantity of Cl is preferable, and the proportion thereof to the entire SiO powders is preferably 1% or less by mass.

2. NMR spectroscopy

Measurement conditions of the spectrum by means of NMR spectroscopy are shown in Table 1. A specimen is kept for three hours at 250° C. in vacuum, undergoes desiccation treatment, is put into a sealed specimen tube, and is measured in that state.

TABLE 1

| | |
|---|---|
| nuclear magnetic resonance | Chemagnetics CMX-300infinity |
| spectroscopy device | |
| measurement method | single pulse method (MAS) |
| measurement frequency | 298.990301 MHz(¹H nucleus) |
| spectrum width | 50.0 kHz |
| pulse width | 4.2 μs (90° pulse) |
| pulse repetition width | ACQTM: 20.48 ms, PD: 5.0 s |
| observation points | 1024 (data points: 16384) |
| reference material | methyl group of polydimethylsiloxane |
| | (external reference: 0.119 ppm) |
| temperature | room temperature (25° C.) |
| specimen rotation speed | 6.0 kHz |

The peak is separated based on the Gaussian distribution for the acquired spectrum, and the mean value, height, and variance are represented respectively by μ, A, and σ², and a peak function fᵢ(x) represented by an equation (1) is acquired.

fᵢ(x)=A[1/{(2π)^{1/2}σ}exp{−(x−μ)²/(2σ²)}] (1)

An area Si of each peak is calculated based on the peak function fᵢ(x) using Sᵢ=∫fᵢ(x)dx. A sum ΣSᵢ of the area Sᵢ of each peak is considered as an entire peak area S, and a ratio of each peak area to the entire peak area is calculated using Sᵢ/S.

### 3. Manufacturing Method of a Negative Electrode Material Powder for a Lithium Ion Secondary Battery According to the Present Invention

### 3-1. Manufacturing Method of SiO Powders

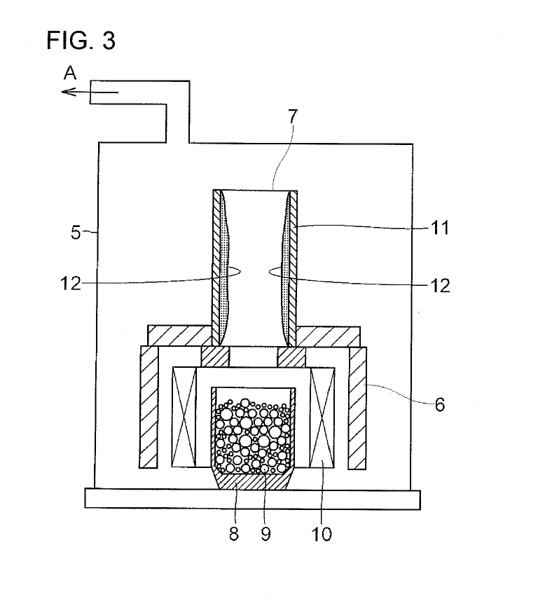

FIG. 3 is a diagram showing a configuration example of a silicon oxide manufacturing device. The device includes a vacuum chamber 5, a raw material chamber 6 arranged in the vacuum chamber 5, and a deposition chamber 7 arranged above the raw material chamber 6.

The raw material chamber 6 comprises a cylindrical body, and a raw material container 8 in a cylindrical shape and a heat source 10 surrounding the raw material container 8 are arranged at a central portion thereof. An electric heater, for example, can be used as heat source 10.

The deposition chamber 7 comprises a cylindrical body arranged so as to be coaxial with the raw material container 8. A deposition substrate 11 made of stainless steel for vapor deposition of silicon oxide in the form of gas which has been generated through sublimation in the raw material chamber 6 is provided on an inner peripheral surface of the deposition chamber 7. The deposition substrate 11 is also heated by a heat source (not shown).

A vacuum device (not shown) that discharges an atmospheric gas is connected to the vacuum chamber 5 that houses the raw material chamber 6 and the deposition chamber 7, and the gas is discharged in the direction indicated by an arrow A.

For manufacturing SiO using the manufacturing device shown in FIG. 3, used is a mixed granulated raw material 9 that is obtained by combining Si powders and SiO₂ powders as raw materials at a predetermined proportion, followed by mixing, granulating, and desiccating. The mixed granulated raw material 9 is filled in the raw material chamber 8, and is heated in an inert gas atmosphere or in vacuum by the heat source 10, thereby generating (sublimating) SiO. The SiO in the form of gas generated through the sublimation moves upward from the raw material chamber 6, enters the deposition chamber 7, is vapor-deposited on the surrounding deposition substrate 11, and is deposited as SiO deposition 12. Then, the SiO deposition 12 is taken out from the deposition substrate 11, and is pulverized by a ball mill or the like, resulting in SiO powders. The granularity of the SiO powders is D50=1 μm−30 μm. D50 refers to a particle diameter or a median diameter when a cumulative weight becomes 50% of the overall weight in a granularity distribution measurement by means of the laser diffraction method.

The temperature of the deposition substrate 11 is between 450° C. and 800° C., and the thickness of the SiO deposition 12 is equal to or less than 10 mm. If the temperature of the deposition substrate 11 is lower than 450° C., the SiO deposition 12 on the deposition substrate 11 is brought into a state of supercooling, dendrites are generated, and the SiO deposition 12 becomes porous. Since structural collapse due to expansion of the SiO powders after repeated charging and discharging occurs earlier in a lithium ion secondary battery using the porous SiO powders as negative electrode material than that in the case where the SiO powders are not porous, the charge/discharge capacity decreases earlier and the cycle characteristics of the lithium ion secondary battery are degraded.

If the temperature of the deposition substrate 11 is higher than 800° C., crystalline Si clusters are generated through a disproportion reaction of SiO. The expansion coefficient of Si during the charging of the lithium ion secondary battery is as large as 4.4 times that of SiO. As a result, in the lithium ion secondary battery using SiO powders in which the crystalline Si clusters are generated as negative electrode material, a structural collapse due to charging/discharging is apt to occur and such lithium ion secondary batteries have inferior cycle characteristics, compared to the case of SiO.

If the thickness of SiO deposition 12 exceeds 10 mm, the SiO itself has low heat conductivity, and it makes difficult to detect the surface temperature of the SiO deposition 12. As a result, even if the temperature of the deposition substrate 11 is equal to or less than 800° C., the surface temperature of the SiO deposition 12 is higher than 800° C., and the disproportion reaction of SiO may occur.

### 3-2. Reforming Treatment Method of SiO Powders

Then, the reforming treatment for the SiO powders is carried out using SiClₓ. The SiO powders obtained by means of the above-mentioned method are put into a heat-resistant container, and are heated by a heating device to the temperature between 500° C. and 900° C. in an Ar atmosphere. Then, a mixed gas of SiClₓ (1≦x≦4) and Ar (the content of SiClₓ is between 0.5% by volume and 50% by volume) is introduced into the heating device, the SiClₓ being heated to the temperature higher than that of the SiO powders by 100° C. or more but by 500° C. or less. As a result of the treatment, the peak area of a chemical shift of 0.2-0.4 ppm becomes between 5% and 40% of the entire peak area in the NMR spectrum of ¹H that is inevitably included in the SiO powders.

If a treatment period is long, SiClₓ disproportion reaction represented by the following formula (2) is generated on the surfaces of SiO powders, and a Si film may be generated on the surfaces of SiO powders.

SiCl_{X}→mSi+nSiCl₄ (2)

where m and n denote coefficients, and are real numbers satisfying the formula (2).

If the thickness of Si film is less than 1 nm, the film does not affect the performance of a lithium ion secondary battery, and if the thickness of the film is between 1 nm and 30 nm, the discharge capacity of the lithium ion secondary battery is increased. However, if the thickness exceeds 30 nm, the Si film expands and breaks up during the charging of lithium ion secondary battery, and the effect of the reforming treatment is thus canceled, resulting in degradation of cycle characteristics of the battery. Moreover, if the Si film is generated, it is sufficient as long as the x of SiO satisfies the relation 0.4≦x≦1.2 while the Si film is considered to be part of SiO powders.

It is necessary to stir the SiO powders for a uniform contact of the SiClₓ gas in the reforming treatment for the SiO powders. Therefore, although a device such as a kiln is preferably used, the method is not limited thereto.

### 3-3. Heat Treatment Method

Then, heat treatment is carried out to remove Cl atoms, which have attached to the surfaces of SiO powders to which the reforming treatment has been applied. The SiO powders to which the reforming treatment has been applied are put into a vacuum heat treatment device in an Ar atmosphere so as not to be brought in contact with air, and are depressurized by a vacuum pump to the pressure between 1 Pa and 10000 Pa. While Ar is flown at a flow rate of 2 L/min-10 L/min in the Ar atmosphere, the temperature inside the device is maintained at between 100° C. and 400° C. The temperature inside the device is preferably between 150° C. and 250° C. Although the period to maintain the temperature is not particularly limited, the period is preferably between one hour and five hours. However, a preferred period to maintain the temperature varies depending on an amount of SiO powders.

### 4. Configuration of Lithium Ion Secondary Battery

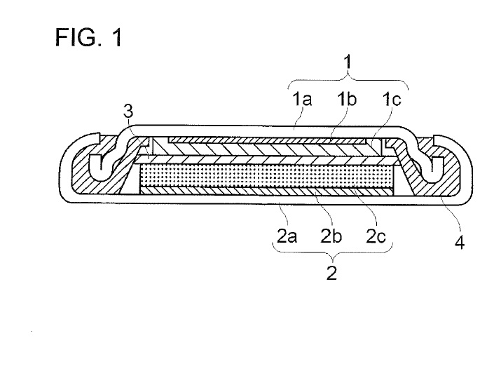

A description will now be given of a configuration example of a lithium ion secondary battery in a coin shape using a negative electrode material powder for a lithium ion secondary battery according to the present invention with reference to FIG. 1. The basic configuration of the lithium ion secondary battery shown in FIG. 1 is as described above.

Negative electrode materials used for a working electrode 2c as being a constituent of a negative electrode 2 may comprise a negative electrode material powder (active material) according to the present invention, other active materials, a conductive additive, and a binder. A content percentage of a negative electrode material powder according to the present invention with respect to the negative electrode materials (ratio by mass of the negative electrode material powder according to the present invention to a total mass of the constituent materials except for the binder among constituent materials of the negative electrode materials) is set to be 20% by mass or more. The active materials other than the negative electrode material powder according to the present invention may not necessarily be added. Acetylene black and carbon black, for example, may be used as conductive additive, and polyvinylidene fluoride, for example, may be used as binder.

### Example

The following tests were carried out, and the results were evaluated in order to confirm the effects of the present invention.

### 1. Test Conditions

Used as raw material was a mixed granulated material obtained by combining silicon powders and silicon dioxide powders, followed by mixing, granulating, and drying, and SiO was deposited on the deposition substrate by using a device shown in FIG. 3. The SiO deposition was pulverized into powders of D50=50 μm with a ball mill made of alumina A molar ratio O/Si (value of x in SiOₓ) of the powders is 1.02. This is because an oxide film is formed on surfaces of powders. The reforming treatment and heat treatment for the SiO powders using SiClₓ were applied to the powders under the conditions shown in Table 2. Moreover, values of ratios (chemical shift peak area ratios) of the peak areas of a chemical shifts of 0.2-0.4 ppm and 1.1-2.0 ppm to the entire peak area in the spectrum of ¹H measured by means of NMR, spectroscopy and the molar ratio O/Si after the heat treatment are also shown in Table 2.

TABLE 2

| | | | | Heat | | Chemical shift peak | | | | Cycle |
|---|---|---|---|---|---|---|---|---|---|---|
| | | SiClₓ | Treatment | treatment | | area ratio (%) | | O/Si | Initial | capacity |
| Test | | concentration | period | temperature | Pressure | 0.2-0.4 | 1.1-2.0 | molar | efficiency | sustainability |
| No. | Classification | (%) | (h) | (° C.) | (Pa) | ppm | ppm | ratio | (%) | (%) |
| 1 | Inventive example | 5 | 7 | 200 | 100 | 5.1 | 48.0 | 0.98 | 90.5 | 95.6 |
| 2 | Inventive example | 10 | 14 | 200 | 100 | 39.5 | 4.5 | 0.89 | 80.1 | 90.2 |
| 3 | Inventive example | 5 | 14 | 180 | 100 | 7.5 | 89.0 | 0.87 | 85.5 | 94.7 |
| 4 | Inventive example | 10 | 11 | 250 | 10 | 21.3 | 51.0 | 0.88 | 97.8 | 97.2 |
| 5 | Comparative example | None | None | None | None | 0.0 | 32.5 | 0.87 | 45.5 | 88.5 |
| 6 | Comparative example | 10 | None | None | None | 44.3 | 29.1 | 1.02 | 50.2 | 64.1 |

Test Nos. 1-4 shown in Table 2 are examples of the present invention, and had peak areas of a chemical shift of 0.2-0.4 ppm between 5% and 40% of the entire peak area in the NMR spectrum. Further, Test Nos. 1, 3, and 4 had a peak area of a chemical shift of 1.1-2.0 ppm between 5% and 95% of the entire peak area in the NMR spectrum. Test Nos. 5-6 are comparative examples, and have the peak area of a chemical shift of 0.2-0.4 ppm less than 5% or more than 40% of the entire peak area in the NMR spectrum.

These SiO powders were used as the negative electrode active material, and carbon black, which was conductive additive, and a binder were combined to the SiO powders, thereby generating the negative electrode material. The constituents for negative electrode material was set to the proportion of SiO powders:carbon black:binder=7:2:1. The negative electrode materials and Li metal as positive electrode material were used to produce the lithium ion secondary battery in a coin shape shown in FIG. 1.

### 2. Test Results

The lithium ion secondary batteries produced under the above-described conditions were evaluated while the initial efficiency and a cycle capacity sustainability rate were used as indicators. The results are shown in Table 2 along with the test conditions. Here, the initial efficiency is a value (%) of a ratio of a discharge capacity to a charge capacity upon the charging/discharging in the first cycle, in which the number of times of charging/discharging is one as being considered to be one cycle. The cycle capacity sustainability rate is the percentage (%) of the discharge capacity for the 100th cycle with respect to the discharge capacity for the first cycle.

In Test No. 6 in the comparative examples, the peak area of a chemical shift of 0.2-0.4 ppm was more than 40% of the entire peak area in the NMR spectrum, the initial efficiency is 50.2%, and the cycle capacity sustainability rate is 64.1%, any of them are low values. Moreover, in Test No. 5, although the peak area of a chemical shift of 0.2-0.4 ppm was less than 5% of the entire peak area in the NMR spectrum, and the initial efficiency was 45.5%, which were a low value; the cycle capacity sustainability rate was 88.5%, which was a more preferable value than that of Test No. 6.

Test Nos. 1-4, which are examples of the present invention, had initial efficiencies of 80.1-97.8%, and cycle capacity sustainability rates of 90.2-97.2%, any of which were excellent values. Particularly, Test Nos. 1, 3, and 4 had peak areas of a chemical shift of 1.1-2.0 ppm between 5% and 95% of the entire peak area, initial efficiencies of 85.5-97.8%, and cycle capacity sustainability rate of 94.7-97.2%, which were more excellent value.

Moreover, it was confirmed that the lithium ion secondary batteries of Test Nos. 1-4 had a larger discharge capacity at the first time than those of Test Nos. 5 and 6.

### INDUSTRIAL APPLICABILITY

A lithium ion secondary battery having an excellent discharge capacity and initial efficiency and satisfactory cycle characteristics can be obtained by using a negative electrode material powder for a lithium ion secondary battery and a negative electrode for a lithium ion secondary battery according to the present invention. Moreover, a lithium ion secondary battery according to the present invention has an excellent discharge capacity and initial efficiency and satisfactory cycle characteristics. The present invention is thus an effective technique in the field of secondary batteries.

### REFERENCE SIGNS LIST

1: Positive electrode
1a: Counter electrode case
1b: Counter electrode current collector
1c: Counter electrode
2: Negative electrode
2a: Working electrode case
2b: Working electrode current collector
2c: Working electrode
3: Separator
4 Gasket
5: Vacuum chamber
6: Raw material chamber
7: Deposition chamber
8: Raw material container
9: Mixed granulated material
10: Heat source
11: Deposition substrate
12: Silicon oxide

1. A negative electrode material powder for a lithium ion secondary battery, comprising SiOₓ (0.4≦x≦1.2), wherein ¹H is inevitably included therein and a peak area of a chemical shift of 0.2-0.4 ppm is between 5% and 40% of an entire peak area in a spectrum of ¹H measured by means of nuclear magnetic resonance spectroscopy.

2. The negative electrode material powder for a lithium ion secondary battery according to claim 1, wherein a peak area of a chemical shift of 1.1-2.0 ppm is between 5% and 95% of the entire peak area in a spectrum of ¹H measured by means of nuclear magnetic resonance spectroscopy.

3. A negative electrode for a lithium ion secondary battery using the negative electrode material powder for the lithium ion secondary battery according to claim 1.

4. A lithium ion secondary battery using the negative electrode for the lithium ion secondary battery according to claim 3.

5. A negative electrode for a lithium ion secondary battery using the negative electrode material powder for the lithium ion secondary battery according to claim 2.

6. A lithium ion secondary battery using the negative electrode for the lithium ion secondary battery according to claim 5.
